(19) United States
(12) Patent Application Publication
(10) Pub. No.: US 2006/0129799 A1
(43) Pub. Date: Jun. 15, 2006

(54) System and method for storing system configuration files

(75) Inventor: Cheng-Meng Wu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/299,398

(22) Filed: Dec. 12, 2005

(30) Foreign Application Priority Data
Dec. 11, 2004 (CN) 200410077484.6

(51) Int. Cl. G06F 9/00

(52) U.S. Cl. 713/100

(57) ABSTRACT

A system for storing system configuration files is disclosed. The system includes a Central Processing Unit (CPU) (1) (CPU) and a memory (2). The memory includes an instruction sending module (21) for sending an instruction for backuping system configurations, a file obtaining module (22) for obtaining system configuration information according to the instruction, a file processing module (23) for generating a system configuration file and a corresponding description file according to the system configuration information and a rule list, encrypting and compressing the system configuration file, and generating a combined file by attaching the system configuration file to the description file. A related method is also disclosed.

### BACKGROUND OF THE INVENTION

1. Field of the Invention

The present invention is generally related to systems and methods for storing files, and more particularly, is related to a system and method for storing system configuration files.

2. Background of the Invention

Many computer programs make use of configuration files to control their behavior. Often these files are relatively simple and with a little experience, a user can configure a program by editing its configuration file in a text editor. However, the configuration files for some programs are long and complex. Consequently, many programs are provided with one or more configuration utilities.

Because contents of system configuration files may include some sensitive data requiring protection, the protection of sensitive data has become an important issue to users of computers. Sensitive data, such as corporate records, credit card numbers, personal data, or other sensitive information may be misappropriated if a computer is stolen, or if an unauthorized individual gains access to a computer network and copies information from some or all of its files or by monitoring and recording the network packets that are transmitted unprotectedly.

A method has been developed in order to solve the problems above. Users can encrypt system configuration files first by using software, and then attach corresponding description information in the name of each system configuration file. However, the method has two distinct disadvantages as below: the first one is that users cannot't effectively distinguish contents of each system configuration file from the file names, if the corresponding description information of the system configuration files are too complicated; the second one is that the users must record the arranged data in the name of system configuration files, if the users want to have the system configuration files list arranged. However, this will add users' workload.

Therefore, what is needed is a system for storing system configuration files, which overcomes the burden of users to identify contents of system configuration files.

Therefore, what is needed is a method for storing system configuration files, which overcomes the burden of users to identify contents of system configuration files.

### SUMMARY

One embodiment of the present invention provides a system for storing system configuration files as described herein. The system includes a Central Processing Unit and a memory, and the Central Processing Unit is connected with the memory via a system bus.

The Central Processing Unit is for obtaining system configuration information according to an instruction for backuping particular system configurations, generating a system configuration file and a corresponding description file according to the obtained system configuration information and a rule list, encrypting and compressing the system configuration file, and generating a combined file by attaching the system configuration file to the description file.

The memory includes a plurality of function modules executable by the central processing unit, system configuration information, system configuration files and respective description files, and a plurality of combined files, the function modules including a determining module, an instruction sending module, a file obtaining module, a file processing module, and a reverting module.

The determining module is for determining whether there is a need to send an instruction for backuping certain system configurations according to user demands. The instruction sending module is for sending the instruction for backuping the system configurations when it is necessary. The file obtaining module is for obtaining corresponding system configuration information according to the received instruction for backuping the system configurations. The file processing module is for generating a system configuration file and a corresponding description file according to the obtained system configuration information, encrypting and compressing the system configuration file, and generating a combined file by attaching the system configuration file to the description file.

Another embodiment of the present invention provides a method for backuping system configurations. The method includes the steps of: (a) sending an instruction for backuping the system configurations; (b) obtaining corresponding system configuration information according to the instruction; (c) generating a system configuration file and a corresponding description file according to the system configuration information and a rule list; (d) encrypting and compressing the system configuration file; and (e) attaching the encrypted system configuration file to the description file, and generating a combined file.

Further, a third embodiment of the present invention provides a method for reverting system configurations. The method includes the steps of: (a1) determining whether it is necessary to revert particular system configurations; (b1) sending an instruction for reverting the system configurations; (c1) obtaining a corresponding combined file according to the instruction for reverting the system configurations; (d1) separating the system configuration file from the combined file; (e1) decrypting and decompressing the system configuration file; and (f1) reverting system configurations according to the system configuration file.

Other objects, advantages and novel features of the embodiments will be drawn from the following detailed description together with the attached drawings, in which:

### BRIEF DESCRIPTION OF THE DRAWINGS

FIG. 1 is a schematic diagram of hardware configuration of a system for storing system configuration files in accordance with a preferred embodiment of the present invention;

FIG. 2 is a schematic diagram of main function modules of a memory of the system of FIG. 1;

FIG. 3 is a flow chart of a preferred method for backuping system configurations by utilizing the system of FIG. 1; and

FIG. 4 is a flow chart of a preferred method for reverting system configurations by utilizing the system of FIG. 1.

### DETAILED DESCRIPTION OF THE PREFERRED EMBODIMENTS

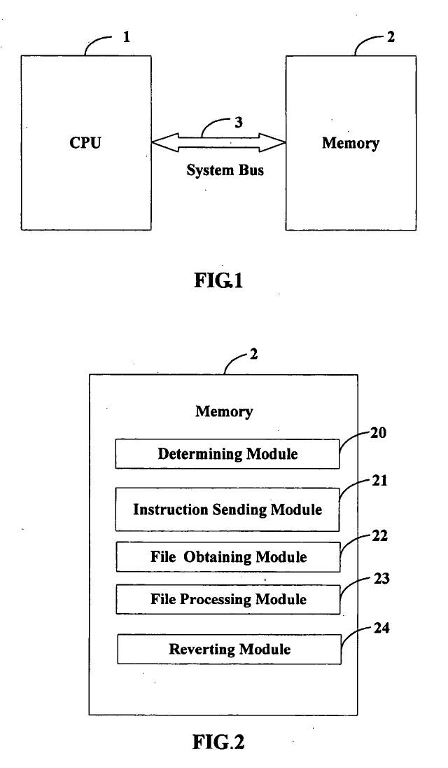

FIG. 1 is a schematic diagram of hardware configuration of a system for storing system configuration files (herein after, “the system”) in accordance with a preferred embodiment of the present invention. The system is installed in a computer (not shown), and typically includes a CPU (Central Processing Unit) 1 and a memory 2. The CPU 1 is connected with the memory 2 via a system bus 3. The CPU 1 is for obtaining system configuration information according to an instruction for backuping particular system configurations, generating a system configuration file and a corresponding description file according to the obtained system configuration information and a rule list, encrypting and compressing the system configuration file, and generating a combined file by attaching the system configuration file to the description file. The CPU 1 can also revert the system configurations according to a corresponding system configuration file when necessary. The system configuration information may include network configurations, user configurations, and device purpose configurations. The description file stores a description of the system configuration file as a reference to users. The memory 2 stores a plurality of function modules (described in detail in FIG. 2), the system configuration information, system configuration files and respective description files, and a plurality of combined files. The function modules in the memory 2 can be invoked and executed by the CPU 1 to perform various functions.

FIG. 2 is a schematic diagram of main function modules of the memory 2. The memory 2 includes a determining module 20, an instruction sending module 21, a file obtaining module 22, a file processing module 23, and a reverting module 24.

The determining module 20 is for determining whether there is a need to send an instruction for backuping certain system configurations according to user demands, and also for determining whether there is a need to revert system configurations according to a system configuration file if any abnormal system configuration condition occurs. The abnormal system configuration condition may include abnormal power-off, system configuration confusion, and software updating. The instruction sending module 21 is for sending the instruction for backuping system configurations and the instruction for reverting system configurations to the file obtaining module 22. The file obtaining module 22 is for obtaining corresponding system configuration information according to the received instruction for backuping system configurations, or obtaining a corresponding combined file according to the received instruction for reverting system configurations. The file processing module 23 is for generating a system configuration file and a corresponding description file according to the obtained system configuration information and a rule list, encrypting and compressing the system configuration file, and generating a combined file by attaching the system configuration file to the description file. The rule list defines which system configuration information stored in the memory 2 belongs to description information. In addition, the file processing module 23 can also separate the system configuration file from the combined file, and decrypt and decompress the system configuration file. The reverting module 24 is for reverting system configurations according to the system configuration file.

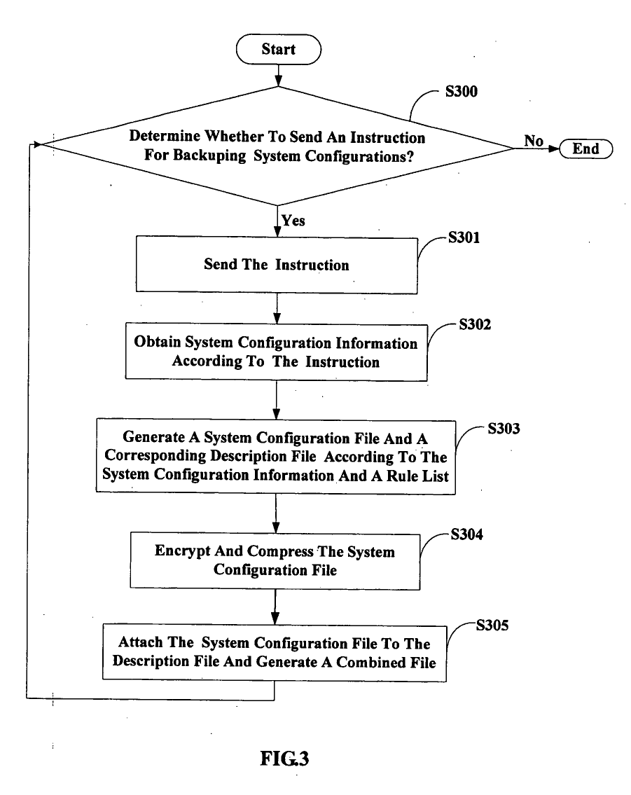

FIG. 3 is a flow chart of a preferred method for backuping system configurations by utilizing the system of FIG. 1. In step S300, the determining module 20 determines whether it is necessary to send an instruction for backuping the system configurations according to user demands. If it is not necessary to send such an instruction, the procedure ends. Otherwise, if it is necessary to send the instruction, in step 301, the instruction sending module 20 in the memory 2 sends the instruction to the file obtaining module 22. In step S302, the file obtaining module 22 obtains corresponding system configuration information from the memory 2 according to the instruction sent from the instruction sending module 21. In step S303, the file processing module 23 generates a system configuration file and a corresponding description file according to the obtained system configuration information and a rule list, and encrypts and compresses the system configuration file in step S304. In step S305, the file processing module 23 generates a combined file by attaching the system configuration file to the description file, and stores the combined file in the memory 2, whereupon the procedure returns to step S300 described above.

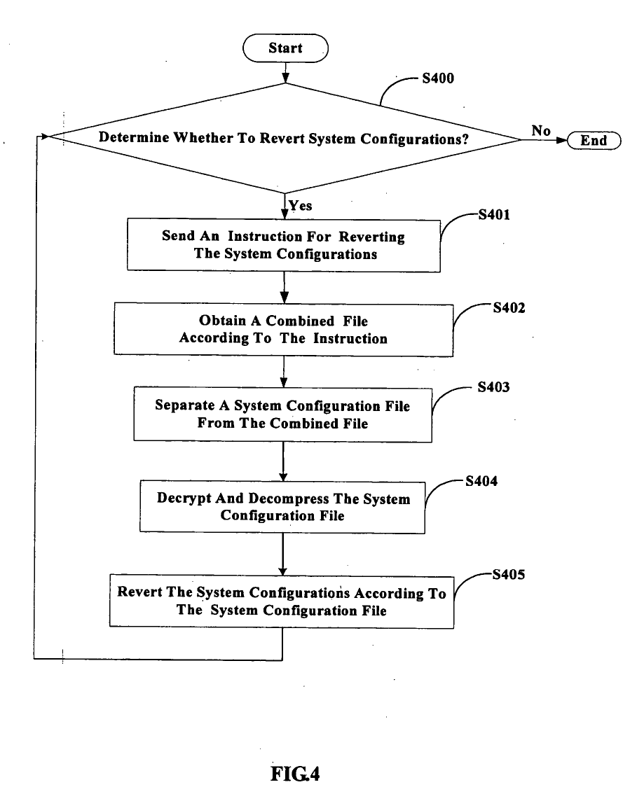

FIG. 4 is a flow chart of a preferred method for reverting system configurations by utilizing the system of FIG. 1. In step S400, the determining module 20 in the memory 2 determines whether it is necessary to revert the system configurations if any abnormal system configuration condition occurs. If it is not necessary to revert the system configurations, the procedure ends. Otherwise, if it is necessary to revert the system configurations, in step S401, the instruction sending module 21 sends an instruction for reverting the system configurations to the file obtaining module 22. In step S402, the file obtaining module 22 obtains a corresponding combined file from the memory 2 according to the instruction for reverting the system configurations. In step S403, the file processing module 22 separates the system configuration file from the combined file. In step S404, the file processing module 22 decrypts and decompresses the system configuration file. In step S405, the reverting module 24 reverts the system configurations according to the system configuration file, whereupon the procedure returns to step S400 described above.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

We claim:

1. A system for storing system configuration files, the system comprising:
a central processing unit; and
a memory for storing a plurality of function modules executable by the central processing unit, for storing system configuration information, system configuration files and respective description files, and a plurality of combined files, the function modules comprising:
a determining module for determining whether there is a need to send an instruction for backuping certain system configurations according to user demands;
an instruction sending module for sending the instruction for backuping system configurations when it is necessary;
a file obtaining module for obtaining corresponding system configuration information according to the received instruction for backuping system configurations; and
a file processing module for generating a system configuration file and a corresponding description file according to the obtained system configuration information, encrypting and compressing the system configuration file, and generating a combined file by attaching the system configuration file to the description file.
a file processing module for generating a system configuration file and a corresponding description file according to the obtained system configuration information, encrypting and compressing the system configuration file, and generating a combined file by attaching the system configuration file to the description file.

2. The system according to claim 1, wherein the file processing module generates the system configuration file and the corresponding description file based on a rule list, the rule list defining which system configuration information stored in the memory belongs to description information.

3. The system according to claim 1, wherein:
the determining module is also for determining whether there is a need to revert system configurations according to a system configuration file if any abnormal system configuration condition occurs;
the instruction sending module is also for sending an instruction for reverting system configurations if there is a need to revert the system configurations;
the file obtaining module is also for obtaining a corresponding combined file according to the received instruction for reverting the system configurations; and
the file processing module is also for separating a system configuration file from the combined file, and decrypting and decompressing the system configuration file.

4. The system according to claim 3, wherein the function modules further include a reverting module for reverting the system configurations according to the system configuration file.

5. A computer-based method for backuping system configurations, the method comprising the steps of:
sending an instruction for backuping the system configurations;
obtaining corresponding system configuration information according to the instruction;
generating a system configuration file and a corresponding description file according to the system configuration information and a rule list;
encrypting and compressing the system configuration file; and
attaching the encrypted system configuration file to the description file, and generating a combined file.

6. The method according to claim 5, wherein the rule list defines which system configuration information belongs to description information.

7. The method according to claim 5, further comprising the step of reverting the system configurations from the combined file.

7. A computer-based method for processing configuration information of a reverting system configurations, the method comprising the steps of:
defining a rule list capable of identifying configuration information as in at least two types thereof comprising at least one type of configuration information out of said at least two types to be under encryption processing and at least another one type to be without experiencing said encryption processing;
utilizing a combined file generated by means of including collectively said at least one type for encryption and said at least another one type without encryption of said at least two types of configuration information; and
processing said configuration information based on said utilization of said combined file.

9. The method according to claim 8, wherein said processing of said configuration information is backuping said configuration information under said encryption processing by means of generating said combined file.

10. The method according to claim 8, wherein said processing of said configuration information is reverting said configuration information from said combined file.
determining whether it is necessary to revert particular system configurations if any abnormal system configuration condition occurs;
sending an instruction for reverting the system configurations if necessary;
obtaining a corresponding combined file according to the instruction for reverting the system configurations;
separating a system configuration file from the combined file;
decrypting and decompressing the system configuration file; and
reverting the system configurations according to the system configuration file.
